(19) United States
(12) Patent Application Publication
(10) Pub. No.: US 2014/0375656 A1
(43) Pub. Date: Dec. 25, 2014

(54) MULTI-LAYER ANIMATION ENVIRONMENT

(71) Applicant: Trigger Happy, Ltd., Auckland (NZ)

(72) Inventor: Karl Butler, Auckland (NZ)

(21) Appl. No.: 14/309,671

(22) Filed: Jun. 19, 2014

Related U.S. Application Data
(60) Provisional application No. 61/836,934, filed on Jun. 19, 2013.

(51) Int. Cl. G06T 13/80

(52) U.S. Cl. CPC G06T 13/80
USPC 345/473

(57) ABSTRACT

A computer-controlled method can include an electronic display visually presenting a digital character and multiple layers within an animation environment, the digital character initially “residing” within a first one of the layers. Responsive to a user “sliding” the digital character in a certain direction, the digital character may “move” to a second one of the layers within the environment.

### CROSS-REFERENCE TO RELATED APPLICATION

This application claims the benefit of U.S. Provisional Patent Application No. 61/836,934, titled “MULTI-LAYER ANIMATION ENVIRONMENT” and filed on Jun. 19, 2013, which is hereby incorporated herein by reference in its entirety.

### TECHNICAL FIELD

The disclosed technology pertains generally to systems for displaying scenes and animations, with particular regard to systems that include the use portable electronic devices such as tablets and smartphones.

### BACKGROUND

The use of portable electronic devices such as tablet computing devices and smartphones has skyrocketed in recent years. Animation, including various types of custom animation, has also seen significant increase in use. Accordingly, there is a continued need for improved custom animation techniques.

### BRIEF DESCRIPTION OF THE DRAWINGS

FIG. 1 illustrates an example of a multi-layer animation environment visually presented on a display of an electronic device.

FIG. 2 illustrates an example of a visual representation of the various layers of the animation environment illustrated by FIG. 1.

FIG. 3 illustrates an example of a technique for “moving” the character between the various layers of the animation environment illustrated by FIGS. 1 and 2 by way of a user performing a particular action.

FIG. 4 shows the character having been “moved” from the third layer to the first layer of the animation environment illustrated by FIGS. 1-3.

### DETAILED DESCRIPTION

Embodiments of the disclosed technology generally pertain to a variety of custom animation tools and techniques that may be executed, performed, and controlled on a computing device such as an Apple® iPhone device, iPad device, or iPod Touch device, or any smartphone, tablet computing device, portable media device, or other type of personal computing device, handheld or otherwise.

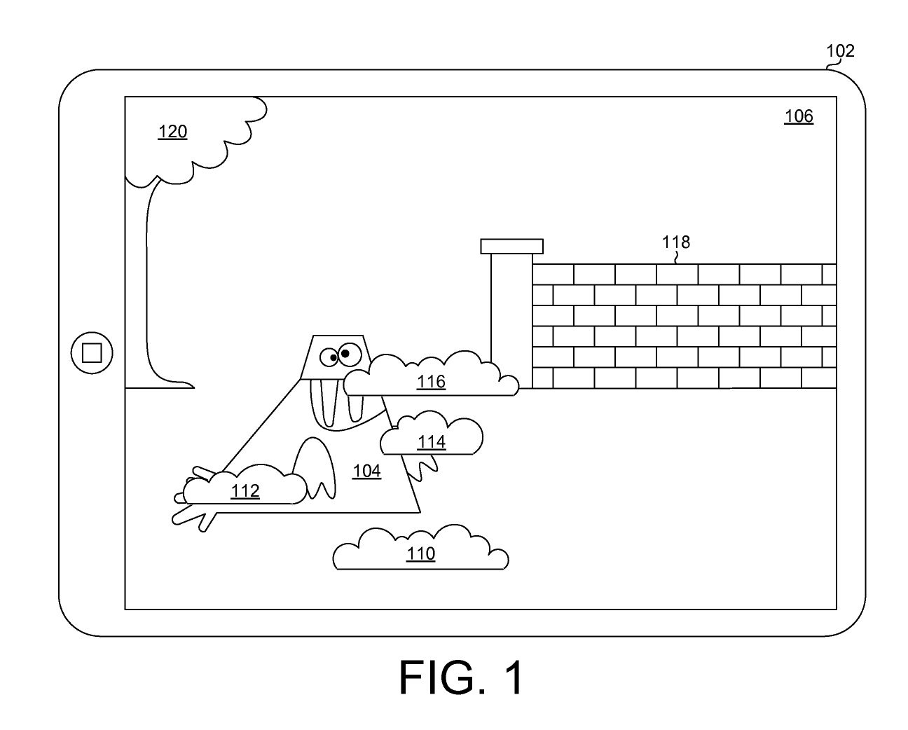

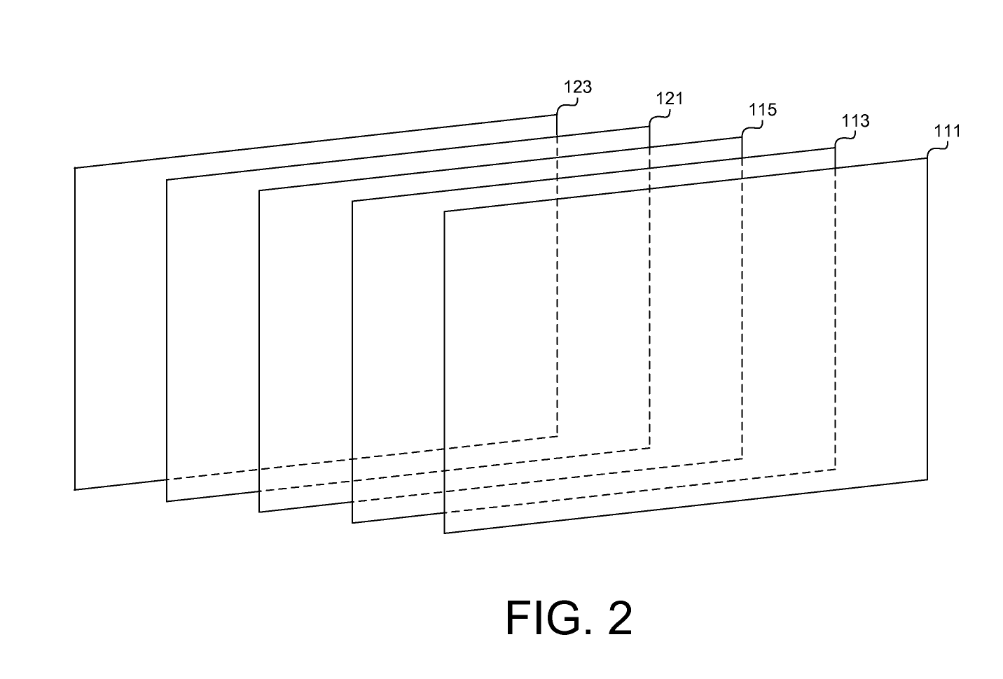

FIG. 1 illustrates an example of a multi-layer animation environment visually presented on a display 106 of an electronic device 102, and FIG. 2 is a visual representation of the various layers 111, 113, 115, 121, and 123 of the animation environment. Various elements may exist on different layers of the environment depending on the elements, characters, animation environment, or combination thereof. A multi-layer animation environment can be created using any of a number of tools or techniques suitable for creating animation environments, or it may be imported from an external application, library, or data store.

It is understood that the layers 111, 113, 115, 121, and 123 are generally presented visually in two dimensions by a display, such as the display 106 of the electronic device 102 of FIG. 1, but are conceptually presented in three dimensions in FIG. 2 to highlight the “stacking” nature thereof. In the example, a first, e.g., “foremost” or “top,” layer 111 exists conceptually in front of a second layer 113, which exists conceptually in front of a third layer 115, which exists conceptually in front of a fourth layer 121, which exists conceptually in front of a fifth layer 123.

While the illustrated example includes five layers, one having ordinary skill in the art will recognize that an animation environment can include fewer layers or more layers; indeed, an animation environment in accordance with the disclosed technology can include virtually any number of layers. Also, the number of layers can be modified using any of a number of suitable tools and techniques.

The illustrated example includes a digital or animated character 104 that may be selected from a library of pre-made characters or imported from an external application or data store. The character 104 may be imported or otherwise placed or moved into any layer of the animation environment. In the example, a first element 110 exists on the first layer 111, a second element 112 exists on the second layer 113, a third element 114 exists on the third layer 115, a fourth element 116 exists on the fourth layer 121, and fifth elements 118 and 120 exist on the fifth layer 123 that, in the example, is also the last, e.g., “backmost” or “bottom,” layer. The character 104 presently exists on the fifth layer 123 of the environment.

The various elements 110, 112, 114, 116, 118 and 120 that each exist on one of the layers 111, 113, 115, 121, and 123 can overlap with one or more other elements or objects that are on a “lower” layer so as to obscure the element(s) to the extent that the “higher” item overlaps the “lower” item(s). For example, because the character 104 is presently on the fifth or final layer 123, the objects 110, 112, 114, and 116 that are on “higher” layers overlap the character 104 and obscure the character 104 to the extent that they overlap the character 104. Consider another example in which the second element 112 (on the second layer 113) were to move, be moved, or caused to be moved “over” the third element 114 (on the third layer 115). In such example, the second element 112 would overlap the third element 114 and thus obscure the third element 114 to the extent that the second element 112 would overlap the third element 114.

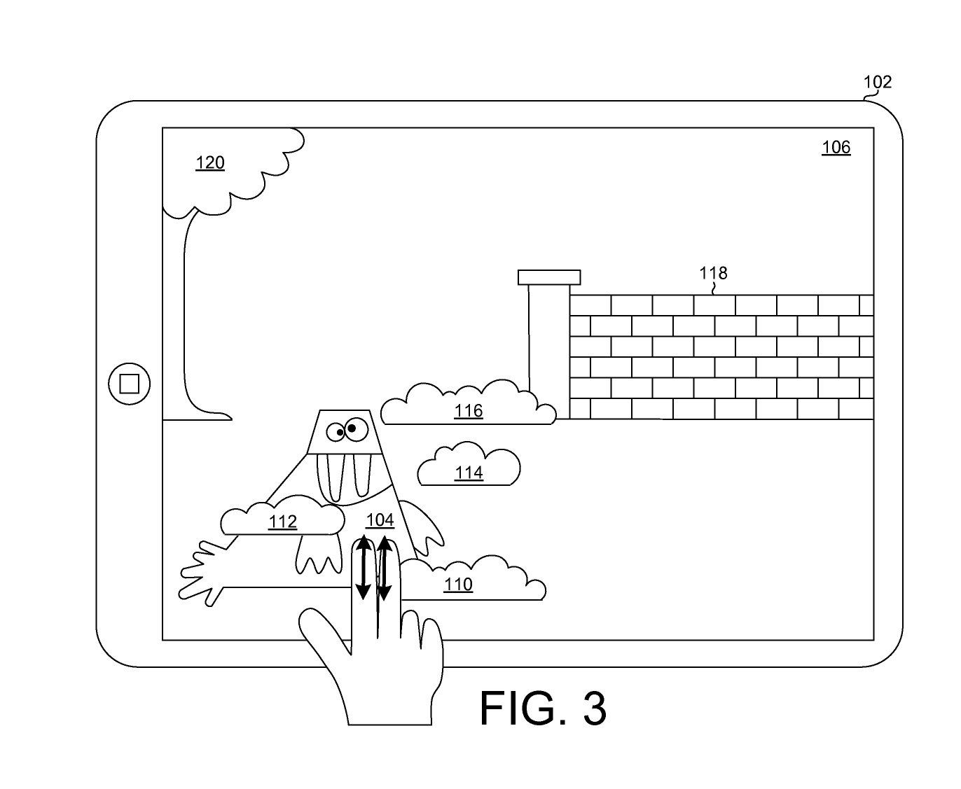

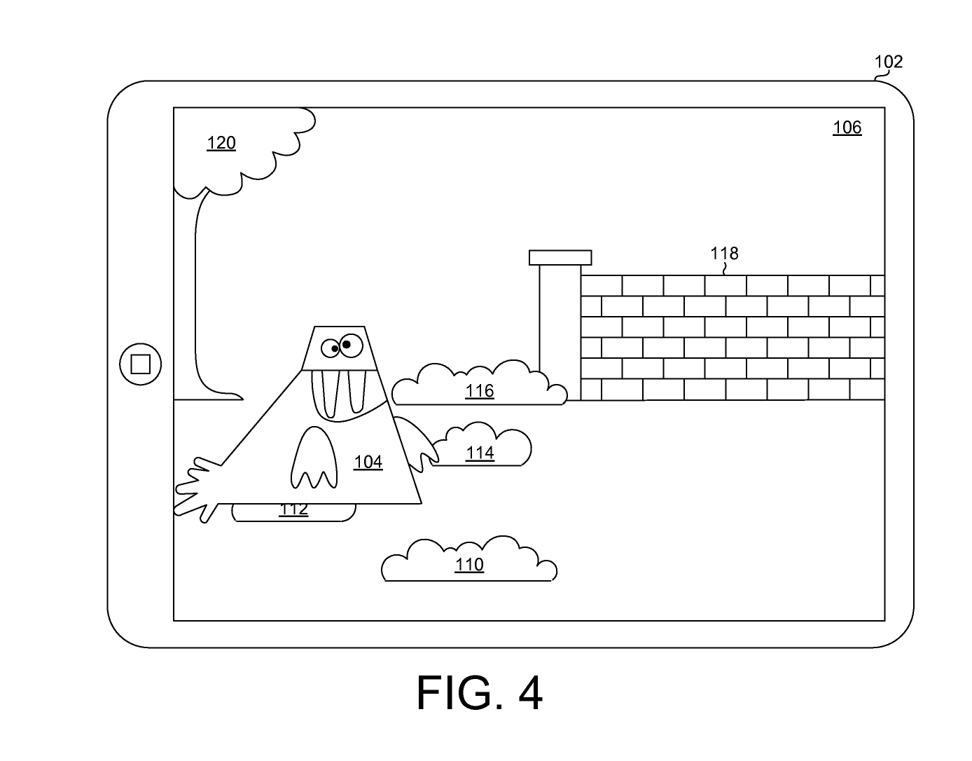

FIG. 3 illustrates an example of a technique for “moving” the character 104 between the various layers 111, 113, 115, 121, and 123 by way of a user performing a particular action. In the example, a user has placed the tips of two of his or her fingers onto the character 104 and can slide them upward or downward on the display. FIG. 3 shows the character 104 having been “moved” from the fifth layer 123 to the third layer 115, e.g., responsive to the user sliding his or her fingers downward. Here, the character 104 would overlap any of the elements 114, 116, 118, and 120 on lower layers (121 and 123) where the character 104 to move or be moved thereover. FIG. 4 shows the character 104 having been “moved” from the third layer 115 to the first layer 111. Here, the character 104 now overlaps the second element 112 because it is on the second layer 113, which is “lower” than the first layer 111.

In general, the higher a user moves his or her fingers up on the display, the “deeper” or “lower” the layer the character 104 will move to. The character 104 will generally exist on the surface of the layer on which it is located at any given time, meaning that it will appear in front of elements on its own layer (and layers therebehind) but appear behind any elements that exist on layers that are higher than the layer on which the character 104 exists.

In certain embodiments, responsive to the character 104 having been moved from one layer to a different layer, the character can either remain the same size or be rescaled. For example, should the character 104 be moved to a lower layer, the character 104 may be visually re-sized to be smaller so as to appear as if deeper in the background. This vanishing point perspective includes a scalar quantity that can be easily calculated and applied to the character 104 by any suitable animation tool or technique.

Any animated motion and/or other associated action of the character 104 can be performed before or after the character 104 moves between different layers. This advantageously allows a user to animate the character's motion/action(s) and then place the character 104 on the desired layer to perform the animation within. Alternatively, the user can move the character to the desired layer and then animate the character on such layer. In either case, the aforementioned size scaling for perspective can be applied to the character 104 after it has been animated and then moved or after the character 104 has been moved then animated.

In certain embodiments, the “path” of the character 104 between layers can be animated as a trace through the layers. In this way, the character 104 can perform one or more motions as it moves between the layers. Again, the aforementioned size scaling of the character 104 for perspective can be done in real-time to further the illusion of depth within the environment as the character moves between the layers.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, communications devices such as cellular phones and smart phones, and the like. These machines may be implemented as part of a cloud computing arrangement.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices, e.g., keyboards, touch screens, mice, and audio devices such as a microphone, as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, non-transitory physical storage media. Certain outputs may be in any of a number of different output types such as audio or text-to-speech, for example.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A computer-controlled method, comprising:
an electronic display visually presenting at least one digital character and a plurality of layers within an animation environment, wherein the digital character “resides” within a first one of the plurality of layers; and
responsive to a user “sliding” the at least one digital character in a first direction, “moving” the at least one digital character to a second one of the plurality of layers.

2. The computer-controlled method of claim 1, further comprising, responsive to the user “sliding” the at least one digital character in a second direction that is substantially opposite the first direction, “moving” the at least one digital character back to the first one of the plurality of layers.

3. The computer-controlled method of claim 1, further comprising, responsive to the user “sliding” the at least one digital character in a second direction, “moving” the at least one digital character to a third one of the plurality of layers.

4. One or more tangible, non-transitory machine-readable storage media configured to store machine-executable instructions that, when executed by a processor, cause the processor to perform the machine-controlled method of claim 1.

5. A computer-controlled method, comprising:
an electronic display visually presenting at least one digital character and a plurality of layers within an animation environment, wherein the digital character “resides” between a first one of the plurality of layers and a second one of the plurality of layers; and
responsive to a user “sliding” the at least one digital character in a first direction, “moving” the at least one digital character to between the first one of the plurality of layers and a third one of the plurality of layers.

6. The computer-controlled method of claim 5, further comprising, responsive to the user “sliding” the at least one digital character in a second direction that is substantially opposite the first direction, “moving” the at least one digital character back to between the first one of the plurality of layers and the second one of the plurality of layers.

7. The computer-controlled method of claim 5, further comprising, responsive to the user “sliding” the at least one digital character in a second direction, “moving” the at least one digital character to between the third one of the plurality of layers and a fourth one of the plurality of layers.

8. The computer-controlled method of claim 5, further comprising, responsive to the user “sliding” the at least one digital character in a second direction, “moving” the at least one digital character to between the second one of the plurality of layers and a fourth one of the plurality of layers.

9. One or more tangible, non-transitory machine-readable storage media configured to store machine-executable instructions that, when executed by a processor, cause the processor to perform the machine-controlled method of claim 5.
